(19) United States
(12) Patent Application Publication
(10) Pub. No.: US 2009/0040028 A1
(43) Pub. Date: Feb. 12, 2009

(54) SYSTEM AND METHOD FOR COMMUNICATING DATA VIA A WIRELESS HIGH SPEED LINK BETWEEN MOBILE COMPUTERS AND ARCHIVAL STORAGE DEVICES

(75) Inventors: William Pat Price, Rhome, TX (US); Gary William Streuter, San Clemente, CA (US); James Sedin, Ketcham, ID (US); Ken Burke, Laguna Hills, CA (US); Randy Deetz, Costa Mesa, CA (US)

Correspondence Address: Law Office of Scott C Harris Inc, PO Box 1389, Rancho Santa Fe, CA, 92067, US

(73) Assignee: CMS PRODUCTS INC, Costa Mesa, CA (US)

(21) Appl. No.: 12/127,997

(22) Filed: May 28, 2008

Related U.S. Application Data
(60) Provisional application No. 60/941,236, filed on May 31, 2007.

(51) Int. Cl. H04Q 5/22; G06F 12/16; G06F 17/30

(52) U.S. Cl. 340/10.51; 707/204; 707/E17.005

(57) ABSTRACT

Desktop and portable computers to backup their data can backup their storage device over a wireless link where the storage device and the computer are always communicating whenever the link is established. Unlike existing technologies that provide wireless access between computers and storage devices the present invention does not require the storage device to be aware of operating systems or file system. All intelligence for file system access and how the data is archived resides with the desktop or portable computer.

### This application claims priority based on provisional application Ser. No. 60/941,236 filed May 31, 2007, the disclosure of which is herewith incorporated by reference.

### BACKGROUND

Data contained on computers is often more valuable than the computer or the storage device associated with the computer. As computers in business have proliferated from large centralized computers to relative inexpensive devices their numbers have increased to the point where most office workers have a computer on their desk. To one extent or another, most workers have become information creators. The information they create is often the life blood of a company and the value of the data normally exceeds the value of the computer itself to create the data.

Once a storage device fails, the data residing on it is usually lost. Over the previous 25 years, companies have tried various methodologies in an attempt to save their valuable data from loss. The methodologies have spawned whole industries devoted to the one task of archiving or backing up data from computers.

These efforts have had limited success at best. Early efforts in the field of backup required expensive peripheral storage devices and required a high cost of entry in terms of user knowledge and time. As the field of backing up data evolved, attempts were made to lower the knowledge required to backup data. Several products on the market only require a user press a button for a backup of their data to occur or only require that a user connect an external storage device to their computer to initiate a backup of their data. Literature in the field of backing up data would suggest that even these simple steps result in only a few percent of workers actually initiating backups.

Automated network backups are known in which backup is carried out to network storage devices with backup software in client computer systems attached to networks. Some of these may continuously back up the data, to avoid the user having to remember to initiate a backup. These systems fall short in that backing up to networks does not guarantee that a user can recover their individual data upon a catastrophic failure of the computer system.

### SUMMARY

Embodiments describe a system and technique which, once installed on the user's computer system, automatically handles all software backup.

With the device installed the user need only be in the vicinity of the backup storage device for the backup to take place. If the user's computer system hard disk drive fails, the user can remove the hard disk drive from their computer system and replace it with the hard disk drive from the wireless storage module; can restore all files from the wireless module, or can selectively transfer digital files from the wireless storage module to the computer system.

### BRIEF DESCRIPTION OF THE DRAWINGS

FIG. 1 depicts an embodiment in a configuration where the storage device and a wireless Transceiver are physically connected together.

FIG. 2 depicts the invention in a configuration where the storage device and a wireless Transceiver are integrated together in a single package.

### DETAILED DESCRIPTION

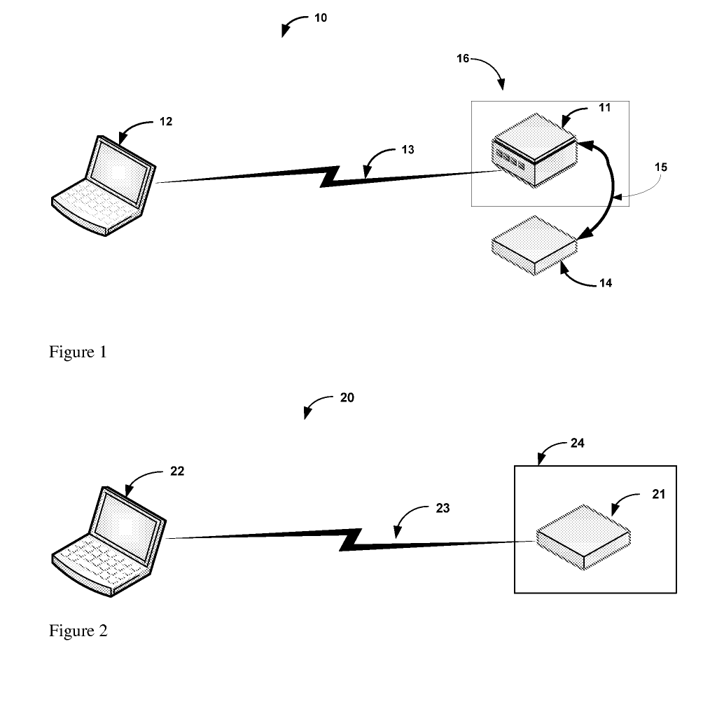

An embodiment of the present invention is depicted in FIG. 1. A system 10 includes a wireless link 13 which connects between a Computer System 12 and backup module 16. The module has a RF Transceiver 11, which can be a wireless Ethernet or Bluetooth transceiver. The RF Transceiver 11 and storage Device 14 are conn**ected through Data Transfer Bus 15. RF Transceiver 11 preferably includes a power supply that controls its operation. FIG. 1 shows a configuration that is configured such that Storage Device 14 fits into the cradle or slot to allow physical connection between the storage device 14 and the transceiver 11. In an embodiment, Data Transfer Bus 15 is connected to RF Transceiver 11 and Storage Device 14 through a set of connectors. One connector connects Storage Device 14 and the other connects RF Transceiver 11 to the Data Transfer Bus 15. Data Transfer Bus 15 would typically be, but is not limited to, standard industry busses such as USB or IEEE 1394 or other network protocol.

FIG. 2 illustrates a second embodiment with said Module 24 representing an integrated package containing the said RF Transceiver, said Storage Device, and power supply. In this embodiment, the RF Transceiver and Storage Device contained inside Module 24 are connected together through a Data Transfer Bus where the connections to said RF Transceiver and said Storage Device are through traces or wires on a printed circuit board, and not through connectors normally specified for the Data Transfer Bus.

A software control Program in Computer System 12 manages the first RF Transceiver 11 to attempt to establish a link or coupling with said Second RF Transceiver using convetional connection software. If the link or coupling cannot be established, said Software Control Program periodically attempt the establishment of the link or coupling until such link or coupling is established. Once the link or coupling is established, said Software Control Program transfers a set of predefined digital files from said first Computer System 12 to said Module 16 and from said Module 16 to said Storage Device 14. Likewise, said Software Control Program can, under direction of the user, cause files contained on said Storage Device 14 to be transferred to first said Computer System 12 through said Module 16 and said RF Wireless Link 13.

The general structure and techniques, and more specific embodiments which can be used to effect different ways of carrying out the more general goals are described herein.

Although only a few embodiments have been disclosed in detail above, other embodiments are possible and the inventors intend these to be encompassed within this specification. The specification describes specific examples to accomplish a more general goal that may be accomplished in another way. This disclosure is intended to be exemplary, and the claims are intended to cover any modification or alternative which might be predictable to a person having ordinary skill in the art. For example, other data formats, other kinds of scales, etc, may be used.

Also, the inventors intend that only those claims which use the words “means for” are intended to be interpreted under 35 USC 112, sixth paragraph. Moreover, no limitations from the specification are intended to be read into any claims, unless those limitations are expressly included in the claims. The computers described herein may be any kind of computer, either general purpose, or some specific purpose computer such as a workstation. The computer may be an Intel e.g., Pentium or Core 2 duo or AMD based computer, running Windows XP or Linux, or may be a Macintosh computer. The computer may also be a handheld computer, such as a PDA, cellphone, or laptop.

The programs may be written in C or Python, or Java, Brew or any other programming language. The programs may be resident on a storage medium, e.g., magnetic or optical, e.g. the computer hard drive, a removable disk or media such as a memory stick or SD media, wired or wireless network based or Bluetooth based Network Attached Storage NAS, or other removable medium or other removable medium. The programs may also be run over a network, for example, with a server or other machine sending signals to the local machine, which allows the local machine to carry out the operations described herein.

Where a specific numerical value is mentioned herein, it should be considered that the value may be increased or decreased by 20%, while still staying within the teachings of the present application, unless some different range is specifically mentioned. Where a specified logical sense is used, the opposite logical sense is also intended to be encompassed.

What is claimed is:

1. A radio frequency RF bi-directional digital data transfer system comprising:
a first computer system comprising:
a storage unit to be backed up;
a software control program running in said first computer system;
a first RF transceiver,
where said software control program is operative to detect a specified backup unit within range of said first RF transceiver, and to automatically backup contents of said storage unit to said backup unit when said backup unit is within range, and at specified periodic increments when said storage unit is in range.

2. A data transfer system as in claim 1, wherein said backup unit comprises a module comprising:
a second RF transceiver;
a power supply; and
a backup storage unit,
wherein said backup storage unit receives backup data via said second RF transceiver, and stores information responsive thereto.

3. A system as in claim 1, where said software control program on said first computer establishes a data transfer link with said second device whenever said computer is within radio range of said second device.

4. A system as in claim 2, wherein said second device includes a data transfer bus which conforms to the Universal Serial Bus USB specifications as defined by the USB organization.

5. A system as in claim 2, wherein said second device includes a data transfer bus which conforms to the IEEE 1394 interface specification.

6. A system as in claim 2, wherein said second device includes a data transfer bus which is connected to both said RF Transceiver and said Storage Device through traces or wires on a printed circuit card and not through normal bus connectors.

7. A system as in claim 1, wherein said software control program contained in said first computer system continuously attempts to establish a link with a remote module and once said link is established said software control program controls transferring a predefined set of files to said storage module over said RF transceiver.

8. A method comprising:
running a computer program on a computer, where the computer program detects a remote storage unit, and automatically establishes a wireless connection with the remote storage unit by detecting wirelessly when the remote storage unit is present, and wherein the computer program running in the computer automatically periodically sends information indicative of files on the computer to said remote storage unit.

9. A method as in claim 8, further comprising the remote storage unit, including a wireless transceiver, and a storage backup device.

10. A method as in claim 9, further comprising a connection between the wireless transceiver and the storage backup device.

12. A method as in claim 9, wherein said wireless transceiver and said storage backup device are integrated into a single unit.
